(19) United States
(12) Patent Application Publication
(10) Pub. No.: US 2006/0092625 A1
(43) Pub. Date: May 4, 2006

(54) Electronic luminescent clothing and tapes

(76) Inventor: Martin McKowen, Gymea Bay (AU)

Correspondence Address: MICHAEL MOLINS;MOLINS & CO., SUITE S, LEVEL 6, 139 MACQUARIE ST, SYDNEY NSW, 2000, AU

(21) Appl. No.: 10/976,800

(22) Filed: Nov. 1, 2004

(51) Int. Cl. F21V 33/00; H05B 33/00

(52) U.S. Cl. 362/108; 362/103; 362/84

(57) ABSTRACT

The invention provides a tape-like structure having electronic luminescent features, which tape may be used in the production of other articles such as safety garments. Accordingly, an electronic luminescent strand (EL) is combined with a tape such as a reflective tape. In some embodiments of the invention, the tape is a retro-reflective tape. In other embodiments the EL is sandwiched between the outer reflective surface of a tape and an inner backing layer.

### FIELD OF THE INVENTION

The invention pertains to safety tapes and more particularly to an electronic luminescent tape and clothing or other articles to which the tape maybe applied.

### BACKGROUND OF THE INVENTION

Reflective tapes and other reflective shaped textiles are used in the production of nighttime and other safety vests and other articles of safety clothing. The tapes provide a surface that reflects an incident light source, primarily as a reflected light, back in the direction that the incident source originated from. Shortcomings in this approach to night safety are the facts that the reflective tapes (a) have no way of producing their own light and are therefore dependent on incident light for their effectiveness and (b) reflect primarily in the direction of the incident source and provide little or no warning light in other directions.

### OBJECTS AND SUMMARY OF THE INVENTION

It is an object of the invention to provide a tape having electronic luminescent features, which tape may be used in the production of other articles.

It is also an object of the invention to provide articles such as safety garments that use electronic luminescent tape.

Accordingly there is provided an electronic luminescent strand (EL) that is combined with a tape such as a reflective tape.

In some embodiments of the invention, the tape is a retro-reflective tape.

In other embodiments the EL is sandwiched between the outer reflective surface of a tape and an inner backing layer.

In yet other embodiments, articles such as safety garments are fabricated using patterns formed from the combination of EL and pre-fabricated tape. The tape may be retro-reflective.

### BRIEF DESCRIPTION OF THE DRAWING FIGURES

FIG. 1 is a front elevation of a safety vest made in accordance with the teachings of the present invention;

FIG. 2 is a cross sectional view of an electronic luminescent tape made in accordance with the teachings of the present invention;

FIG. 3 is a cross sectional view of another electronic luminescent tape made in accordance with the teachings of the present invention;

FIG. 4 is a cross sectional view of another embodiment of an electronic luminescent tape made in accordance with the teachings of the present invention;

FIG. 5 is a schematic wiring diagram of a garment showing deployment of ELT;

FIG. 6 is a cross sectional view of yet another embodiment of an electronic luminescent tape made in accordance with the teachings of the present invention;

FIG. 7 is a schematic diagram of ELT fabrication; and

FIG. 8 is a schematic diagram of an EL strand moulded into a structure.

### BEST MODE AND OTHER EMBODIMENTS OF THE INVENTION

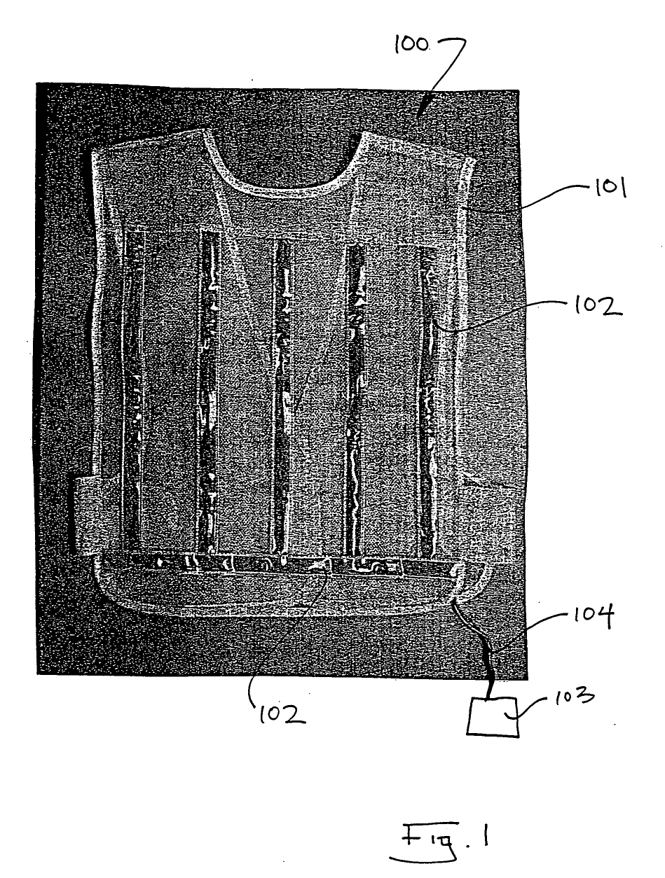

As shown in FIG. 1 by way of example, a safety garment such as a vest 100 comprises a sleeveless textile garment or substrate 101 to which is attached a plurality of electronic luminescent tapes (“ELT”) 102 forming a pattern. As will be explained, the ELTs emits a pattern of light when the individual ELTs are supplied power from a battery operated driver 103 which is connected to the ELT structure by a lead or harness 104. The term ELT describes a family of EL based tapes having a variety of front and back surface combinations.

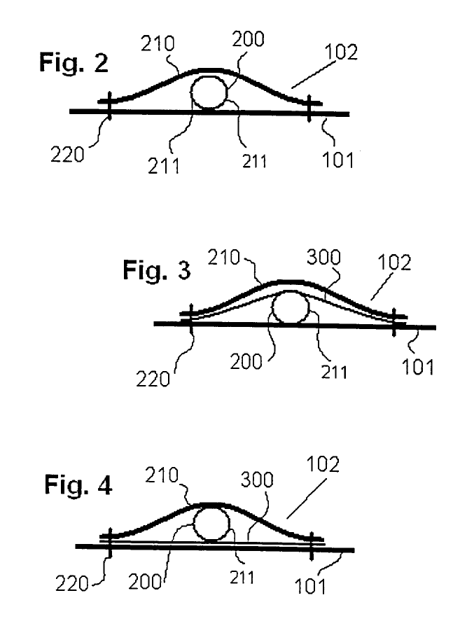

As shown in FIG. 2, each ELT 102 comprises an electronic luminescent strand or structure (EL) 200 integrated into a tape. EL structures 200 are a form of light emitting diode (LED) that is fabricated as wires, ribbons, or strands. The EL glows along its length and can be cut with wire cutters and joined to an electrical circuit at the cut end. The EL 200 generally has two conductors which run internally of an insulating and transparent or translucent polymer sheath 211. The sheath 211 may be coloured or clear. When low voltage power is supplied to the conductors, the EL emits light. The colour of the emitted light can be influenced by the sheath.

Conventional tape such as a retro-reflective tapes are formed, in lengths, from a granular or other reflective front surface 210. As shown in FIG. 2, a length of EL can be positioned between or sandwiched between a reflective tape 210 (having generally parallel side edges) and another textile substrate 101 which may be a garment or other textile. Stitching 220 may be applied to the edges of the tape 210 to secure the tape 21 and the EL 200 to the substrate 101. It will be understood that adhesives, sonic welding etc. maybe used in place of stitching in all examples.

FIG. 3 illustrates that if the reflective tape 210 has a separate coextensive backing 300 and if the backing is transparent enough, the EL can be positioned between the backing 300 and the substrate 101. Here and in the claims, “transparent” incorporates a wide range of transparency or translucency, so long as the structure allows light from an EL to pass through it.

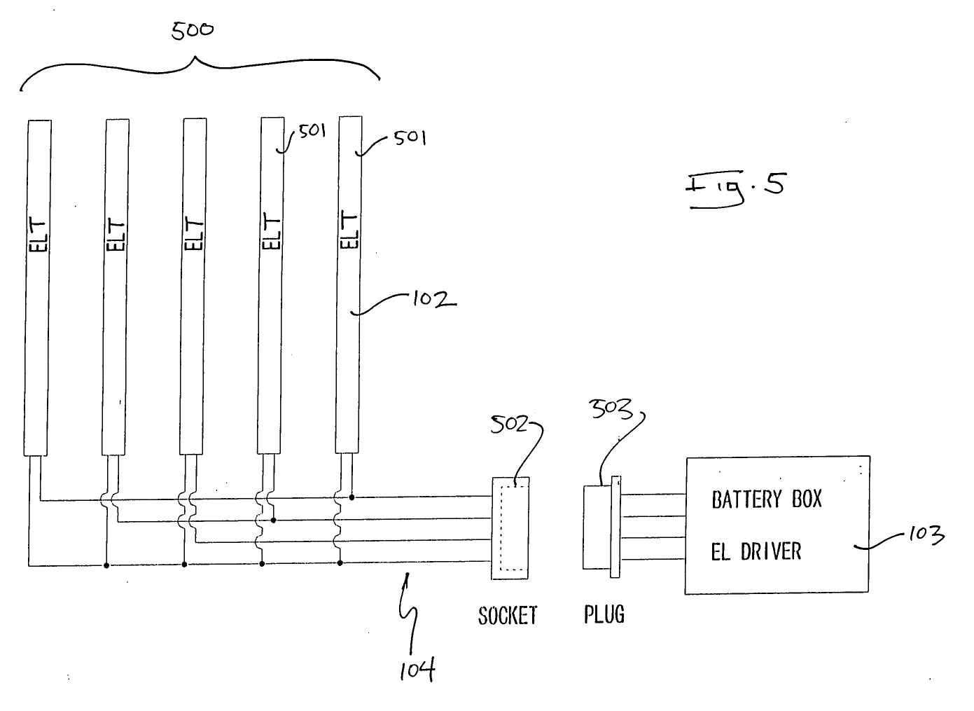

As shown in FIG. 4, a preferred embodiment locates the length of EL 200 between the reflective or other front surface 210 of the tape 102 and the backing 300. Stitching 220 is used to assemble the tape 102 first by sandwiching the EL 200 between the reflective or other front surface 210 of the tape 102 and the backing 300. In the alternative, the reflective or other surface 210, EL 200, backing 300 and substrate 101 may be joined together in one stitching pass 220.

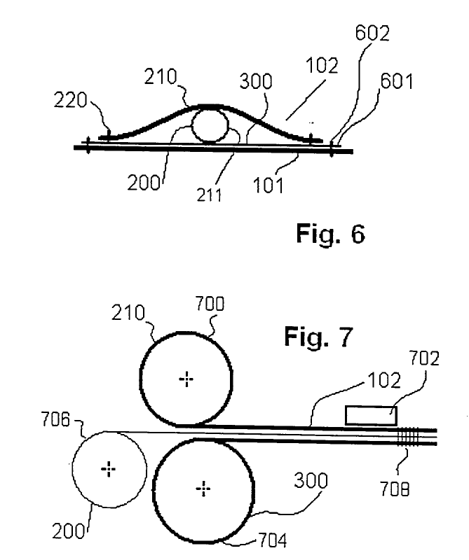

All of the methods and tape structures illustrated in FIGS. 2, 3 and 4 are suitable for the production of electronic luminescent tapes (ELT) in long lengths which can be cut to length and used in the production of other articles such as safety clothing. Such tapes may be pre-fabricated in lengths or rolls of considerable length for later use on garments. As shown in FIG. 6, when EL tape (ELT) 102 is manufactured in lengths for later use, the backing may be provided with landings or margins 601 that extend past the stitches 220 that hold the backing to the front surface 210. This provides room for later stitches 602 that are used to attach the pre-fabricated tape 102 to the substrate 101. In one embodiment, the ELT may have a retro-reflective front surface 210. This provides a tape that is functional as a reflective tape (even when no power is supplied) and a light emitting tape when power is supplied to the EL. In the alternative, the backing 300 may be reflective or retro-reflective and the front surface 210 may be transparent or translucent. In some embodiments, neither surface is reflective.

As shown in FIG. 5, a simple pattern of ELT 500 comprises an array of separate ELT lengths 501 which are electrically connected to a wiring harness 104. The harness may terminate in a socket 502 so that it can be conveniently connected to a cooperating plug 503 that delivers power from a driver and battery compartment or box 103. It will be appreciated that the low voltage output of the box 103 can be modulated by an integrated circuit or by other means to produce patters of flashing, blinking and apparent movement in the array 500. Patterns of moving, blinking or flashing lights attract more attention than stationary lights and also potentially consume less power.

As shown in FIG. 7, lengths of front surface material from rolls 700 are joined by a stitching or gluing machine 702 to lengths of backing material from a second roll 704. The EL strand 706 is sandwiched between the two lengths and captured there by the stitching 708.

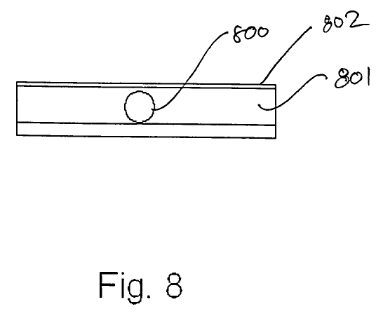

As depicted in FIG. 8, an EL strand 800 can be embedded into or moulded into a tape, a reflective tape, a lens, a matrix of lenses, an array of lenses or a length of lens-like material 801. In this embodiment the EL 800 is about 1-5 mm in diameter. The tape 801 or lens structure 801 is moulded around the EL 800 so as to encapsulate it. The moulded structure 801, 800 may be composited with or bonded to a surface such as a reflective surface 802 or a backing tape 803 or both of these.

While the invention has been disclosed with reference to particular patterns and garments and other details of construction, these are provided by way of example and not as limitations to the scope or spirit of the invention.

What is claimed is:

1. An electronic luminescent structure, comprising:
an electronic luminescent strand that is sandwiched between a substrate and a first tape.

2. The electronic luminescent structure of claim 1, wherein:
the first tape is a tape having a reflective surface.

3. The electronic luminescent structure of claim 1, wherein:
the first tape has a separate, transparent backing that is coextensive with it.

4. The electronic luminescent structure of claim 1, wherein:
the electronic luminescent strand is sandwiched between a first tape and a backing tape.

5. The electronic luminescent structure of claim 4, wherein:
the first tape or the backing tape has reflective surface.

6. The electronic luminescent structure of claim 4, wherein:
the backing tape is wider than the first tape, providing margins on either side of the first tape.

7. A garment on which is formed a pattern, the pattern formed from an electronic luminescent structure comprising an electronic luminescent strand that is sandwiched between a substrate and a first tape.

8. The garment of claim 7, comprising:
a battery operated driver for the electronic luminescent structure.

9. The garment of claim 8, further comprising:
a wiring harness that attaches an electronic luminescent structure to the driver.

10. The garment of claim 9, wherein:
there are two or more electronic luminescent structures forming a pattern and the harness attaches each electronic luminescent structure to the driver.

11.-17. (canceled)

18. An electronic luminescent structure, comprising:
a substrate into which is moulded an electronic luminescent strand.

19. The structure of claim 18, wherein:
the substrate is a lens.

20. The structure of either of claim 18, wherein:
the substrate is bonded to a backing tape.
